(19) United States
(12) Patent Application Publication
(10) Pub. No.: US 2013/0231784 A1
(43) Pub. Date: Sep. 5, 2013

(54) Systems, Methods and Vehicles For Controlling Home Automation

(71) Applicants: Christopher Lee Rovik, Canton, MI (US); Charan S. Lota, Canton, MI (US); Donald Anthony Restauri, III, Ypsilanti, MI (US)

(72) Inventors: Christopher Lee Rovik, Canton, MI (US); Charan S. Lota, Canton, MI (US); Donald Anthony Restauri, III, Ypsilanti, MI (US)

(73) Assignee: Toyota Motor Engineering & Manufacturing North America, Inc., Erlanger, KY (US)

(21) Appl. No.: 13/409,748

(22) Filed: Mar. 1, 2012

(51) Int. Cl. G05D 23/19; G05B 15/02

(52) U.S. Cl. 700/276; 700/275

(57) ABSTRACT

A vehicle for controlling home automation may include network interface hardware, one or more processors, and input/output hardware. The one or more processors can be communicatively coupled to the network interface hardware. The input/output hardware can be communicatively coupled to the one or more processors. The one or more processors can execute logic to receive a location signal indicative of a location of a vehicle. An input portal can be presented automatically on the input/output hardware when the location of the vehicle is within a predetermined range. An actuation signal indicative of a mechanical input can be received. A control signal can be transmitted to a home automation computing device via the network interface hardware. The control signal can be operable to actuate a function of an electrical device communicatively coupled to the home automation computing device.

### TECHNICAL FIELD

The present specification generally relates to systems, methods and vehicles for controlling home automation and, more specifically, to systems, methods and vehicles for controlling home automation over a communication network.

### BACKGROUND

Home automation can be utilized to provide a centralized control system for various electrical components within a home. Additionally home automation can provide a remote interface to the electrical components such as, for example, appliances, lighting, entertainment systems, security systems, and garage doors. Such electrical components of the home automation system can be controlled and monitored through communication systems such as telephone lines and the internet. Accordingly home automation systems can provide convenience, comfort and energy savings. However, many users of home automation systems also spend time within a vehicle and have limited access ability to control the home automation system while in the vehicle.

Accordingly, a need exists for alternative systems, methods and vehicles for controlling home automation systems over a communication network.

### SUMMARY

In one embodiment, a vehicle for controlling home automation may include network interface hardware, one or more processors, and input/output hardware. The one or more processors can be communicatively coupled to the network interface hardware. The input/output hardware can be communicatively coupled to the one or more processors. The one or more processors can execute logic to receive a location signal indicative of a location of a vehicle. An input portal can be presented automatically on the input/output hardware when the location of the vehicle is within a predetermined range. An actuation signal indicative of a mechanical input can be received. A control signal can be transmitted to a home automation computing device via the network interface hardware. The control signal can be operable to actuate a function of an electrical device communicatively coupled to the home automation computing device.

In another embodiment, a system for controlling home automation may include a network, a home automation computing device, and a vehicle. The home automation computing device can be communicatively coupled to the network. The home automation computing device may include one or more home processors and can be communicatively coupled to an electrical device. The vehicle can be communicatively coupled to the network. The vehicle may include one or more vehicle processors, and input/output hardware communicatively coupled to the one or more vehicle processors. The one or more home processors, the one or more vehicle processors, or both can execute logic to receive a location signal indicative of a location of a vehicle. An input portal can be presented automatically on the input/output hardware of the vehicle when the location of the vehicle is within a predetermined range. An actuation signal indicative of a mechanical input can be received. A function of the electrical device can be actuated.

In yet another embodiment, a method for controlling home automation may include receiving a location signal indicative of a location of a vehicle. A visual indication that the location of the vehicle is within a predetermined range can be presented automatically with a processor. An actuation signal indicative of a mechanical input with an input portal can be received. A control signal to a home automation computing device can be transmitted via network interface hardware of the vehicle. The control signal can be operable to actuate a function of an electrical device communicatively coupled to the home automation computing device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a networked system for controlling home automation according to one or more embodiments shown and described herein;

FIG. 2 schematically depicts a method for controlling home automation according to one or more embodiments shown and described herein; and

FIG. 3 schematically depicts a vehicle according to one or more embodiments shown and described herein.

### DETAILED DESCRIPTION

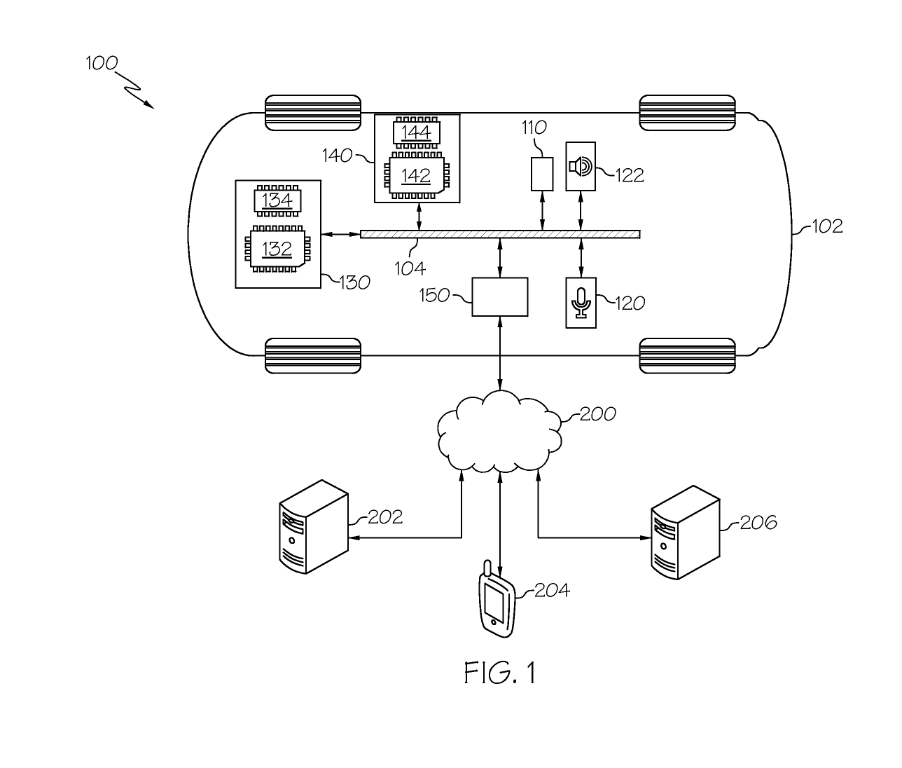

FIG. 1 generally depicts one embodiment of a vehicle configured to control electrical devices within a home controlled by a home automation computing device. The vehicle generally comprises one or more processors for executing logic and a plurality of communicatively coupled modules, which generally includes network interface hardware that enables communication between the vehicle and the home automation computing device. Various embodiments of the vehicle and the operation of the vehicle will be described in more detail herein.

Referring now to FIG. 1, an embodiment of a networked system 100 comprising a vehicle 102 is schematically depicted. It is noted that, while the vehicle 102 is depicted as an automobile, the vehicle 102 may be any passenger or non-passenger vehicle such as, for example, a terrestrial, aquatic, and/or airborne vehicle. The vehicle 102 may comprise a communication path 104 that provides data interconnectivity between various vehicle modules disposed within the vehicle 102. Accordingly, the communication path 104 communicatively couples any number of vehicle modules with one another, and allows the vehicle modules to operate in a distributed computing environment. Specifically, each of the vehicle modules can operate as a node that may send and/or receive data. In one embodiment, the communication path 104 can comprise a conductive material that permits the transmission of electrical data signals to processors, memories, sensors, and actuators throughout the vehicle 102. In another embodiment, the communication path 104 can be a vehicle bus, such as for example a LIN bus, a CAN bus, a VAN bus, and the like. In further embodiments, the communication path 104 may be wireless or, alternatively, an optical waveguide. As used herein, the term “communicatively coupled” means that the components are capable of exchanging data signals with one another such as, for example, electrical signals via conductive medium, electromagnetic signals via air, optical signals via optical waveguides, and the like.

The vehicle 102 generally comprises input/output hardware communicatively coupled with the communication path 104. The input/output hardware serves as an interconnection between a driver and the vehicle 102. The input/output hardware can be any device capable of transforming mechanical, optical, or electrical signals into a data signal capable of being transmitted with the communication path 104. Moreover, the input/output hardware can be any device capable of transforming a data signal into a mechanical, optical, or electrical output. Each individual component of the input/output hardware can optionally include one or more processors and one or more memories. Alternatively, each individual component of the input/output hardware can optionally omit a processor and/or a memory. Accordingly, it is noted that, while specific components are described herein as including a processor and/or a memory, the embodiments described herein should not be so limited.

In one embodiment, the input/output hardware can include a tactile input device 110 such as, for example, a button, a switch, a knob, or the like. The physical motion of the tactile input device 110 can be digitized into a data signal that can be transmitted to a vehicle component. The input/output hardware can further include a microphone 120 for receiving input from a user. The microphone 120 can be any sensor that transforms mechanical vibrations into a data signal. The term “sensor,” as used herein, means a device that measures a physical quantity and converts it into a data signal, which is correlated to the measured value of the physical quantity, such as, for example, an electrical signal, an electromagnetic signal, an optical signal, a mechanical signal, or the like.

The input/output hardware may also include a speaker 122 for transforming data signals into mechanical vibrations. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Still referring to FIG. 1, the input/output hardware can include one or more displays for visually presenting data. The one or more displays can be located throughout the passenger compartment of the vehicle 102 and can include any medium capable of transmitting an optical output such as, for example, a cathode ray tube, light emitting diodes, liquid crystal displays, plasma displays, or the like. Each of the one or more displays can be a touchscreen that, in addition to providing optical information, detects the presence and location of a tactile input upon a surface of or adjacent to the display. Accordingly, each display can receive mechanical input directly upon the optical output provided by the display.

In one embodiment, the vehicle 102 may include an audio head unit display 130 communicatively coupled with the communication path 104. The audio head unit display can comprise an audio processor 132 communicatively coupled to an audio memory 134. The vehicle 102 may further include an instrument cluster display 140 communicatively coupled with the communication path 104. The instrument cluster display can comprise a cluster processor 142 communicatively coupled with a cluster memory 144. Additionally, it is noted that, while the each of the audio head unit display 130 and the instrument cluster display 140 are depicted in FIG. 1 as including an integral processor and memory, each of the audio head unit display 130 and the instrument cluster display 140 may be implemented without a processor and/or a memory. For example, any of the processors described herein may be separately located within any component communicatively coupled with the communication path 104. Accordingly, the vehicle 102 may include a plurality of components each having one or more processors that are communicatively coupled with one or more of the other components. Thus, the embodiments described herein may utilize a distributed computing arrangement to perform any portion of the logic described herein.

According to the embodiments described herein, a processor means any device capable of executing machine readable instructions. Accordingly, each processor may be a controller, an integrated circuit, a microchip, a computer, or any other computing device. The memory described herein may be RAM, ROM, a flash memory, a hard drive, or any device capable of storing machine readable instructions.

Embodiments of the present disclosure comprise logic that includes machine readable instructions or an algorithm written in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the logic or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, or as a combination of hardware and software components.

Moreover, the logic can be distributed over various components that are communicatively coupled over a network 200 that may include one or more cellular networks, satellite networks and/or computer networks such as, for example, a wide area network, a local area network, personal area network, a global positioning system and combinations thereof. Accordingly, the vehicle 102 can be communicatively coupled to the network 200 via wires, via a wide area network, via a local area network, via a personal area network, via a cellular network, via a satellite network and the like. Suitable local area networks may include wired ethernet and/or wireless technologies such as, for example, Wi-Fi. Suitable personal area networks may include wireless technologies such as, for example, IrDA, Bluetooth, Wireless USB, Z-Wave, ZigBee, and the like. Alternatively or additionally, suitable personal area networks may include wired computer buses such as, for example, USB and FireWire. Suitable cellular networks include, but are not limited to, technologies such as LTE, WiMAX, UMTS, CDMA, and GSM. Thus, any components of the vehicle 102 can utilize one or more network 200 components to transmit signals over the Internet or World Wide Web.

In one embodiment, the vehicle 102 comprises network interface hardware 150 for communicatively coupling the vehicle 102 with the network 200. The network interface hardware 150 can be communicatively coupled to the communication path 104 and can be any device capable of transmitting and/or receiving data via the network 200. Accordingly, the network interface hardware 150 can include an antenna and/or other communication transceiver for sending and/or receiving any wired or wireless communication. For example, the network interface hardware 150 may include an antenna, a modem, LAN port, wireless fidelity (Wi-Fi) card, WiMax card, mobile communications hardware, near-field communication hardware, satellite communication hardware and/or any wired or wireless hardware for communicating with other networks and/or devices.

The network 200 can communicatively couple the vehicle 102 to other devices in a flexible client-server relationship, i.e., the vehicle 102 can be a server to and/or a client of any device communicatively coupled to the vehicle 102 via the network 200. Specifically, the network 200 can be configured to enable the delivery of cloud resources to and/or from the vehicle 102. Any device communicatively coupled to the vehicle 102 can deliver a cloud resource to the vehicle 102 via the network 200. Similarly, the vehicle 102 can deliver a cloud resource via the network 200 to any device communicatively coupled to the vehicle 102. Accordingly, cloud resources such as, for example, processing, storage, software, and information can be shared via the network 200.

Referring still to FIG. 1, a networked system 100 for implementing one or more of the embodiments for controlling home automation disclosed herein is depicted. The network 200 may be utilized to communicatively couple a vehicle 102, one or more remote computing devices 202, one or more mobile devices 204, and a home automation computing device 206. Accordingly, each of the vehicle 102, one or more remote computing devices 202, the one or more mobile devices 204, and the home automation computing device 206 can be communicatively coupled to one another directly or indirectly via the network 200. For example, one or more devices communicatively coupled to the network 200 can operate as an intermediary to transmit data between any of the other devices. Accordingly, the network 200 can facilitate a distributed computing arrangement amongst the vehicle 102, the one or more remote computing devices 202, the one or more mobile devices 204, and the home automation computing device 206. Specifically, any of the devices communicatively coupled to the network 200 can share cloud resources such that each communicatively coupled device can perform any portion of the logic described herein.

As is noted above, the vehicle 102 can be communicatively coupled to the one or more remote computing devices 202 via the network 200. Each of the one or more remote computing devices 202 can comprise one or more processors and one or more memories. The one or more processors can execute logic to provide cloud resources to the vehicle 102 and/or any other device communicatively coupled to the network 200. For example, the one or more remote computing devices 202 can provide supplementary processing power, via relatively high powered processors, to the vehicle 102. Additionally, the one or more remote computing devices 202 can provide supplementary data storage to the vehicle 102. Moreover, the one or more remote computing devices 202 can provide platforms such as, for example, a social networking service, news service, weather service, traffic service, map service (e.g., restaurant data, fuel station data, service station data), and any other service capable of being exchanged between a server and a client.

The networked system 100 may further comprise one or more mobile devices 204 communicatively coupled to the vehicle 102 via the network 200. Each of the one or more mobile devices 204 can comprise one or more processors and one or more memories. Accordingly, the one or more mobile devices 204 can operate as a client and/or a server with respect to the vehicle 102. The one or more mobile devices 204 may be configured as a cellular or mobile telephone, with functionality for wireless data communications. Thus, while the mobile device 204 is depicted herein as a mobile telephone, it should be understood that the mobile device 204 can be any mobile communications device that can exchange data via a mobile telecommunication service such as, for example, a personal digital assistant, a smart phone, or a laptop computer with a wireless communication peripheral. Furthermore, it is noted that one or more mobile devices 204 may further be configured to communicate data via one or more cellular networks, satellite networks and/or computer networks. In one embodiment, the network interface hardware 150 of the vehicle 102 can be communicatively coupled to the one or more mobile devices 204 via a personal area network such that the one or more mobile devices 204 communicatively couples the network interface hardware 150 to the network 200.

The networked system 100 further comprises a home automation computing device 206 that can be communicatively coupled to the vehicle 102 via the network 200. The home automation computing device 206 can comprise one or more processors and one or more memories. The home automation computing device 206 executes logic to automatically cause home or household functions to be performed. For example, the home automation computing device can be communicatively coupled to any electrical device within a home such as, for example, lighting, heating, ventilation and air conditioning (HVAC), appliances, entertainment systems, security systems, and garage door openers.

The home automation computing device 206 may further comprise home network interface hardware similar to the network interface hardware 150 of the vehicle 102. Accordingly, the home automation computing device 206 can communicate with the network 200 in any manner that the vehicle 102 communicates with the network 200. However, it is noted that the vehicle 102 and the home automation computing device 206 need not communicate with the network in the same manner.

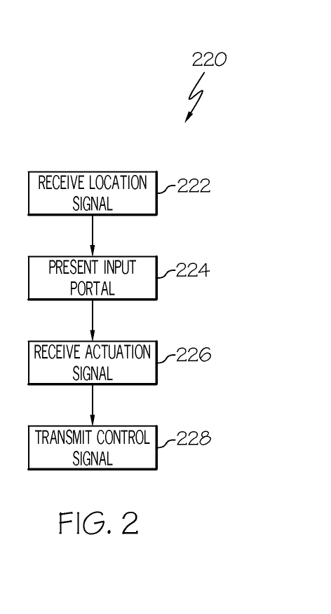

Referring collectively to FIGS. 1 and 2, in one embodiment, the audio processor 132 and/or the cluster processor 142 can execute logic to transmit a control signal to the home automation computing device 206. A method 220 for automatically controlling a home automation computing device 206 from a vehicle 102 is depicted in FIG. 2. The method 220 includes a process 222 wherein a location signal indicative of a location of the vehicle 102 is received. In one embodiment, a global positioning satellite can transmit a signal indicative of the location of the vehicle 102 via the network 200 to the audio processor 132. In another embodiment, the home automation computing device 206 can transmit a signal with a limited range via the network. Specifically, the home automation computing device 206 can ping the vehicle via any communication protocol accepted by the network 200. For example, the home automation computing device 206 can ping the vehicle with a Wi-Fi network.

The method 220 may further comprise a process 224 that presents an input portal on the input/output hardware of the vehicle 102 when the vehicle 102 is within a predetermined range such as, for example, when the vehicle 102 is less than a predetermined distance from a home controlled by the home automation computing device 206. In one embodiment, the audio processor 132 can execute logic to compare the location of the vehicle 102 to the location of the home controlled by the home automation computing device 206. For example, the location of the home can be stored on a memory within the vehicle 102 such as the audio memory 134. Alternatively or additionally, the location of the home can be stored in a memory provided as a cloud resource by the network 200. In another embodiment, the audio processor 132 can execute logic to determine if the vehicle 102 is within the predetermined range when the ping signal is received. Specifically, when the ping signal is transmitted via Wi-Fi, the vehicle can be determined to be within the predetermined range upon receiving the ping signal.

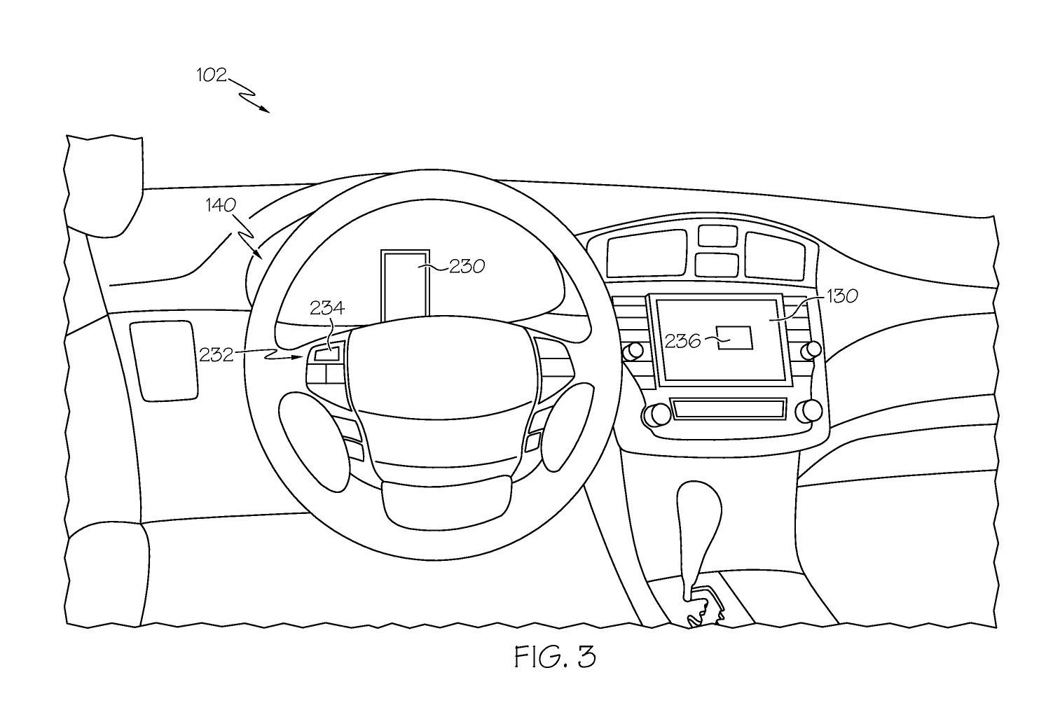

Referring now to FIG. 3, the input portal can be presented via any input/output hardware of the vehicle 102. In one embodiment, the input portal can be presented as an illuminated symbol 230 on the instrument cluster display 140. Specifically, when the vehicle 102 is within the predetermined range, a portion of the instrument cluster display can be activated to present the illuminated symbol 230 as a visual indication.

In another embodiment, the input portal can be presented on a configurable tactile input 232. The configurable tactile input 232 can be any tactile input that includes selectively activated components and functions. Specifically, the configurable tactile input 232 can be transitioned between an activated state, where the configurable tactile input 232 provides a signal when actuated, and a deactivated state, where the configurable tactile input 232 provides no signal when actuated. Moreover, the configurable tactile input 232 may be selectively set to control different functions, i.e., the button can alternate between providing data signals to any device or component described herein. For example, the configurable tactile input 232 can be configured to control a vehicle function such as radio volume when the vehicle 102 is outside of the predetermined range, and configured to control the exterior lighting of a home when the vehicle 102 is within the predetermined range.

The configurable tactile input 232 can include an optical output device 234 that is disposed on the configurable tactile input 232 or adjacent to the configurable tactile input 232. Accordingly, when the vehicle 102 is within the predetermined range, the configurable tactile input 232 can be set to provide any desired component or function. For example, in one embodiment, when the vehicle 102 is within the predetermined range, the optical output device 234 can provide a visual indication (e.g., color coded light or text) that the configurable tactile input 232 is available to control the home automation computing device 206.

In a further embodiment, input portal can be presented on a touchscreen region 236 of the audio head unit display 130. Specifically when the vehicle 102 is within the predetermined range, a visual indication that the touchscreen region 236 is available to control the home automation computing device 206 can be provided. Contemporaneously, the touchscreen region 236 of the audio head unit display 130 can be operable to detect the presence and/or location of a tactile input upon a surface of or adjacent to the touchscreen region 236 of the audio head unit display 130.

Referring again to FIGS. 1 and 2, the method 220 may further comprise a process 226 that receives an actuation signal indicative of a mechanical input. Specifically, the input/output hardware can be operated as a sensor that detects mechanical input such as, for example, a pressure, a sound, a location, and the like. Once the mechanical input is detected, the input/output hardware can transform the mechanical input into the actuation signal. The actuation signal can then be transmitted to any processor via the communication path 104 and/or the network interface hardware 150.

Referring again to FIG. 3, in one embodiment, the mechanical input can be detected by the configurable tactile input 232. For example, a user can press the configurable tactile input 232 to generate the actuation signal. In another embodiment, the mechanical input can be detected by the touchscreen region 236 of the audio head unit display 130. Specifically, a user can place an object (e.g., a finger or stylus) upon or adjacent to the touchscreen region 236 of the audio head unit display 130 to generate the actuation signal.

Referring again to FIG. 1, in a further embodiment, the mechanical input can be detected by the microphone 120. For example, the microphone can detect a voice prompt and transform the voice into a voice signal. In some embodiments, the voice signal can be transformed into the actuation signal such as, for example, by voice recognition software which can be executed by any processor communicatively coupled to the communication path 104 of the vehicle 102. Alternatively, the voice signal can be utilized directly as the actuation signal.

Referring again to FIGS. 1 and 2, the method 220 may further comprise a process 228 that transmits a control signal to the home automation computing device 206. Specifically, the actuation signal can be received by a processor that executes logic and causes the network interface hardware 150 to transmit a signal to the network 200. The control signal can be received by the home automation computing device 206. Based at least in part upon the received signal, the home automation computing device 206 can execute logic to actuate a function of the home automation computing device 206. Accordingly, any electrical device within the home controlled by the home automation computing device 206 can be actuated.

For example, the control signal can cause lights within the home and/or exterior lights to turn on and/or off. The control signal can be utilized to set the temperature of the HVAC system of the home. In some embodiments, the control signal can be utilized to activate and/or deactivate the home security system. In further embodiments, the control signal can be operable to cause the garage door opener to actuate.

It should be now be understood that the embodiments described herein can be utilized to provide a vehicle centric cloud resource network. The cloud resource network can be utilized to coordinate vehicle components and a home automation computing device. For example, an input portal can be provided automatically within the vehicle when the vehicle is near (e.g., within one mile, a few blocks, within the range of a Wi-Fi network, or within any predetermined range) the home controlled by the home automation computing device. The input portal can be actuated to generate a control signal from the vehicle that operates any electrical device within the home that is communicatively coupled to the home automation computing device.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle for controlling home automation comprising:
network interface hardware;
one or more processors communicatively coupled to the network interface hardware; and
input/output hardware communicatively coupled to the one or more processors, wherein the one or more processors execute logic to:
receive a location signal indicative of a location of a vehicle;
present, automatically, an input portal on the input/output hardware when the location of the vehicle is within a predetermined range;
receive an actuation signal indicative of a mechanical input; and
transmit a control signal to a home automation computing device via the network interface hardware, wherein the control signal is operable to actuate a function of an electrical device communicatively coupled to the home automation computing device.

2. The vehicle of claim 1, wherein the input/output hardware comprises a display, and the input portal is provided as an optical output by the display.

3. The vehicle of claim 2, wherein the mechanical input is received directly upon the optical output provided by the display.

4. The vehicle of claim 1, further comprising a microphone communicatively coupled to the one or more processors, wherein the mechanical input is a mechanical vibration received by the microphone.

5. The vehicle of claim 1, wherein the network interface hardware is communicatively coupled to one or more mobile devices via a personal area network, and the one or more mobile devices communicatively couples the network interface hardware to the home automation computing device.

6. The vehicle of claim 1, wherein the location signal is provided by a global positioning satellite system.

7. The vehicle of claim 6, wherein the one or more processors execute logic to compare the location signal and the predetermined range.

8. The vehicle of claim 1, wherein the input/output hardware comprises a configurable tactile input, and the input portal is provided with the configurable tactile input.

9. The vehicle of claim 8, wherein the one or more processors execute logic to activate the configurable tactile input when the location of the vehicle is within the predetermined range.

10. The vehicle of claim 8, wherein the configurable tactile input comprises an optical output device that is located on or adjacent to the configurable tactile input and the one or more processors execute logic to illuminate the optical output device when the location of the vehicle is within the predetermined range.

11. The vehicle of claim 1, wherein the electrical device is a light and the control signal actuates the light.

12. The vehicle of claim 1, wherein the electrical device is an HVAC system and the control signal sets a temperature of the HVAC system.

13. The vehicle of claim 1, wherein the electrical device is a home security system and the control signal deactivates the home security system.

14. The vehicle of claim 1, wherein the electrical device is a garage door opener, and the control signal actuates the garage door opener.

15. A system for controlling home automation comprising:
a network;
a home automation computing device communicatively coupled to the network, wherein the home automation computing device comprises one or more home processors and is communicatively coupled to an electrical device;
a vehicle communicatively coupled to the network, the vehicle comprising one or more vehicle processors, and input/output hardware communicatively coupled to the one or more vehicle processors, wherein the one or more home processors, the one or more vehicle processors, or both execute logic to:
receive a location signal indicative of a location of a vehicle;
present, automatically, an input portal on the input/output hardware of the vehicle when the location of the vehicle is within a predetermined range;
receive an actuation signal indicative of a mechanical input; and
actuate a function of the electrical device.

16. The system of claim 15, wherein the electrical device is a light, an HVAC system, a home security system, or a garage door opener.

17. The system of claim 15, wherein the network comprises a cellular network, a satellite network, a computer network, or a combination thereof.

18. The system of claim 15, wherein the input/output hardware of the vehicle comprises a configurable tactile input and an optical output device that is located on or adjacent to the configurable tactile input, and wherein the one or more home processors, the one or more vehicle processors, or both execute logic execute logic to illuminate the optical output device when the location of the vehicle is within the predetermined range.

19. The system of claim 15, wherein the input/output hardware of the vehicle comprises a display, the input portal is provided as an optical output by the display, and the mechanical input is received directly upon the optical output provided by the display.

20. A method for controlling home automation comprising:
receiving a location signal indicative of a location of a vehicle;
presenting, automatically with a processor, a visual indication that the location of the vehicle is within a predetermined range;
receiving an actuation signal indicative of a mechanical input with an input portal; and
transmitting a control signal to a home automation computing device via network interface hardware of the vehicle, wherein the control signal is operable to actuate a function of an electrical device communicatively coupled to the home automation computing device.
